(19) United States
(12) Patent Application Publication
(10) Pub. No.: US 2011/0174742 A1
(43) Pub. Date: Jul. 21, 2011

(54) METHOD AND DEVICE FOR WATER RENOVATION

(76) Inventor: Holger Blum, Teufen (CH)

(21) Appl. No.: 13/001,395

(22) PCT Filed: Jun. 12, 2009
(86) PCT No.: PCT/EP2009/004259

§ 371 Date: Mar. 30, 2011

(30) Foreign Application Priority Data
Jun. 24, 2008 (DE) 10 2008 029 923.5

(51) Int. Cl. C02F 1/463; C02F 1/461; C02F 1/52; C02F 1/32; C02F 9/06

(52) U.S. Cl. 210/748.1; 205/751; 204/222; 210/251

(57) ABSTRACT

With a method for renovating wastewater, the wastewater is fed into an electro flocculation cell (E) and is subject to electro flocculation. The electro flocculate (WF) processed in the electro flocculation cell is fed into a ripening tank (R) and remains there. The electro flocculate (WF) originating from the ripening tank is filtered in a filter (F). The device for renovating wastewater comprises an electro flocculation cell (E), a ripening tank (R) connected downstream of the electro flocculation cell (E), and a filter (F) connected downstream of the ripening tank. The electro flocculation cell (E) is provided with moveable electrodes. The ripening tank (R) comprises a ventilation element (R18) for feeding air.

The invention relates to a method and a device for water renovation, and in particular to a renovation plant for purifying the sewage liquid from miniature particles up to a diameter smaller than 20μ and resolved pollutants.

A modern water renovation is supposed to provide drinking water which corresponds in quality to a national drinking water. In a plant for drinking water renovation, untreated water or dirty water, respectively, is processed with physical, biological and chemical treatment mechanisms such that, at the end of the renovation, drinking water is available according to the required standards.

A drinking water renovation close to nature should orient itself on processes which go on also in nature for purifying the water.

It is already known that wastewater from a biological purification plant which water contains miniature particles smaller than 20μ and dissolved pollutants, can be purified thereby that the wastewater is directed through an electro flocculation cell having movable electrodes according to PCT/EP/2006/005384, and thereby that the obtained flocculate is directed, downstream of the electro flocculation cell, directly into a filter and sterilizing device according to DE-U-20 2006 019 492.

This method for renovating water by means of an electro flocculation cell and by hydraulically downstream serially connected gravity filter device and ultraviolet flow-through cell is described by Dr. J. Strunkheide and A. Höcherl in the paper WWT (Wasserwirtschaft Wassertechnik=water management and water technology) April 2008, pages 10 to 14 with the title “Process water renovation”, ISSN 1438-5716.

The water purification according to the above described method comes with only a fraction of the cost expenditure which has to be provided for the so-called reverse osmoses since the expenditure in energy and materials is very low.

The above described water renovation plant has the deficiency that a readjustment of the parameters of the individual, sequential device stages is required during the operation of the plant as soon as the product from pollutant amount and through-flowing quantity of the wastewater, the so-called pollutant freight, deviates essentially from a previously determined value.

This readjustment requires an additional manual or automatic change in the operation parameters of the electro flocculation cell, such as the change of the current load or the change of the cell voltage. In case such readjustment is omitted, derivations from the required purity in the drainage of the last element of the water renovation plant, the ultraviolet through-flow cell, are encountered.

Through the requirement of the readjustment in case of varying pollutant freight of the wastewater, the expenditure in personal and the expenditure for control and transmission devices is disadvantageously put up whereby the advantages of the device for water renovation according to WWT (Wasserwirtschaft Wassertechnik) April 2008, pages 10 to 14, are put down in a critical way.

It is the object of the invention to provide a method and a device for water renovation which comprises the advantages of the method which is described in WWT (Wasserwirtschaft Wassertechnik=water management and water technology) April 2008, pages 10 to 14 without having to carry out a readjustment of the parameters of the individual, sequential apparatus stages during the operation of the plant.

It is further object of the invention to provide a device for water renovation which is, with the same throughput rate, especially more compact than the plant which is described in WWT (Wasserwirtschaft Wassertechnik=water management and water technology) April 2008, pages 10 to 14.

For achieving this objective, a method according to the invention for renovating wastewater is given in which the wastewater is fed into an electro flocculation cell and subjected there to an electro flocculation, in which the electro flocculate which was processed in the electro flocculation cell, is fed into a ripening tank and remains there, and by which the electro flocculate originating from the ripening tank is filtered in a filter.

This method has the advantage that it can be carried out in a compactly constructed device. By means of the ripening process in the ripening tank, the electro flocculate is transformed into an easily filterable condition with the capability of good reverse washing which also contributes to the compactness of the required plant. Furthermore, the method is designed such that a readjustment of the parameters of the individual, sequential apparatus stages during the operation of the device is not required.

An advantageous embodiment of the invention is characterized in that the electro flocculate is enriched by air prior to being fed to the filter whereby the filtration of the electro flocculate is further improved.

A further advantageous embodiment of the invention is characterized in that the dwell time of the electro flocculate in the ripening tank amounts to about 0.5 to 3 hours which has proven, in an advantage way, as a sufficient period of time such that the ripening process in the ripening tank can be finished with an advantage result.

A further advantageous embodiment of the invention is characterized in that the water is forwarded under pressure through the filter whereby the through put through the device is improved.

A further advantageous embodiment of the invention wherein the filter comprises a filter bed with granular filter material, is characterized in that, in the filter, an overpressure is built up which is sufficient to press the electro flocculate (WF) through the filter bed.

A further advantageous embodiment of the invention is characterized in that the water originating from the filter, is irradiated by an UV-light-purification device with ultraviolet light in order to disinfect the finally produced, purified water.

For achieving the above stated object, according to the invention, a device for renovation of wastewater is provided which comprises an electro flocculation cell, a ripening tank connected downstream of the electro flocculation cell, and a filter connected downstream of the ripening tank. The device has the advantage that it is compact and can be operated with heavily flocculating wastewater loads without readjustment of the operation parameters.

Furthermore, one arrives at a low required area of the complete device for water renovation when taking the route of the invention, since a lot of space is saved by the omission of the gravity filter device.

The above described compact device for water renovation provides a surprising number of important technical advantages. With the device of the invention for water renovation, no personal or technical measurements for readjustment of the operation parameters are required in case the wastewater load of the wastewater is subject to large fluctuations.

Thereby, the production and the construction of the inventive device for water renovation is essentially simplified. The electro flocculation cell thereof can now be standardized into a few unit sizes whereby the problem of the replacement and the exchange of used-up cell is removed or minimized, respectively.

A further safeguard for the case of unusual operation conditions consists in that the inventive device for water renovation is, to a large extend, immune against an interruption of the raw water supply or against current failure during the operation whereby the device automatically changes over into a stand-by condition between two filtration cycles.

An advantageous embodiment of the inventive device is characterized in that the electro flocculation cell is constructed with movable electrodes and comprises an intake for wastewater and a drainage for the electro flocculate.

By moving the electrodes, it can be prevent, in an advantage way, that the filter is clogging up.

A further advantageous embodiment of the inventive device is characterized in that the electro flocculation cell comprises an upper and a lower electrode which is movable, wherein the lower electrode comprises a bed out of metal particles and the upper electrode out of metal is mechanically oscillated, in particular because of the fact that the lower electrode is formed by a bed out of metal particles, the electrode material can easily be replaced when the previously present electrode material has been used up.

A further advantageous embodiment of the inventive device is characterized in that the metal particles consists out of cast iron chips or out of magnesium granulate or out of aluminum granulate or out of a granular aluminum magnesium alloy which has proven to be a low cost and efficient consumable material.

A further advantageous embodiment of the inventive device is characterized in that the ripening tank comprises an ventilation element for supplying air.

A further advantageous embodiment of the inventive device is characterized in that the ripening tank is constructed as an unpressurized tank.

A further advantageous embodiment of the inventive device is characterized in that the ripening tank is divided up by means of separating walls into several sub-tanks which are hydraulically connected to each other by means of openings in the separating walls. Thereby, the settling of the heavy particles at the bottom of the ripening tank is promoted.

A further advantageous embodiment of the inventive device is characterized in that the sub-tanks of the ripening tank comprise aeration tubes.

A further advantageous embodiment of the inventive device is characterized in that the filter comprises a filter bed out of moveable, granular filter material.

A further advantageous embodiment of the inventive device is characterized in that the filter comprises a pressure container. Because of the simple and compact structure of the pressure filter tank, the maintenance expenditure is very low and results in only a minimal hydraulic energy consumption.

A further advantageous embodiment of the inventive device is characterized in that the filter is capable of being back-washed.

Thereby a prolonged life time of the filter is ensured thereby that the filter can, on demand, be placed back into a fully functional state by means of back-washing.

A further advantageous embodiment of the inventive device is characterized in that granular filter material of the filter consists out of zeolite, in particular out of clinoptilolite which has proven, in a advantageous way, as particularly suitable for the filter used according to the invention.

A further advantageous embodiment of the inventive device is characterized in that the granular filter material consists out of the zeolite material clinoptilolite with a fine grading of at least 94 weight % clinoptilolite.

Because of the fine grading of the clinoptilolite, the filter efficiency is optimized.

A further advantageous embodiment of the inventive device is characterized in that a UV light purification device is connected downstream of the filter in order to further purify the filtered water.

A further advantageous embodiment of the inventive device is characterized in that the UV light purification device has the shape of a box like channel within which horizontally below the liquid level, one or several ultraviolet radiators are arranged and in which an overflow weir for sterile, purified water is provided.

This device is a particularly simple way in order to sterilize the purified water additionally with UV light.

A further advantageous embodiment of the inventive device is characterized in that a purified water tank is provided. By means of a purified water tank, it is possible to intermediately store the purified water prior to being drained from the plant. The purified water can than, at least in part, be used in the plant itself if necessary.

A further advantageous embodiment of the inventive device is characterized in that the purified water tank is formed as an unpressurized tank.

A further advantageous embodiment of the inventive device is characterized in that the purified water tank contains the back-washing water for the filter.

Thereby, in an advantageous way, the purified water is provided which is required for the back-washing of the filter.

A further advantageous embodiment of the inventive device is characterized in that the purified water tank has the 4-fold to 6-fold volume of the filter such that, in case of a back-washing, sufficient water is at hand without the purified water tank being drained empty.

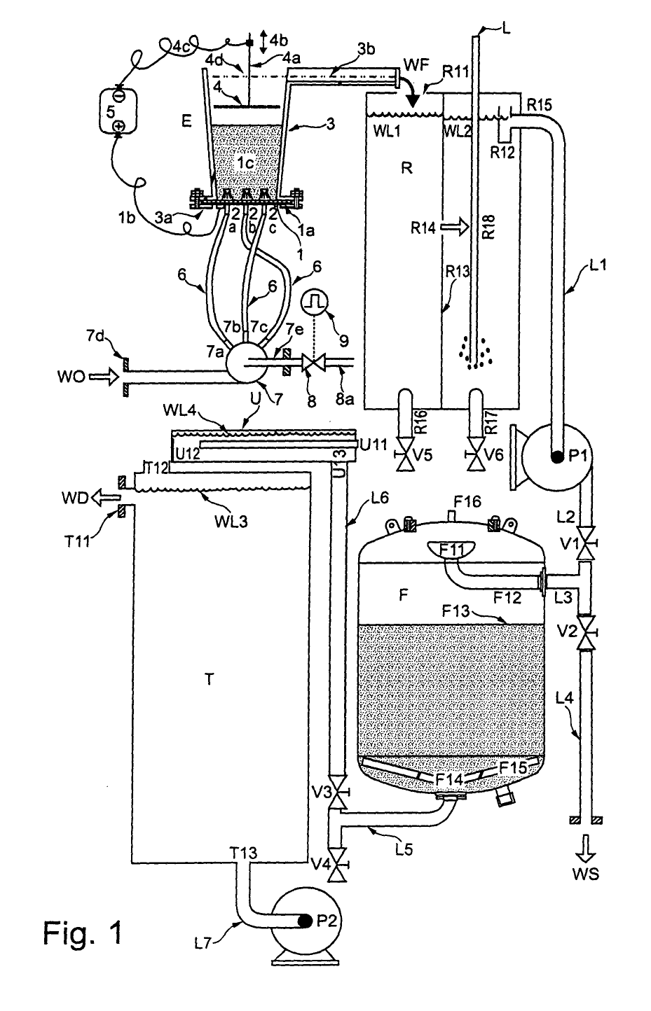

Embodiments of the invention are now explained with reference to the attached FIG. 1 which shows the flow scheme of the inventive device for water renovation in a schematically way.

The invention is directed to liquids of all kind, however, it is described in the following with reference to the renovation of water since this area is an essential area of application.

The renovation of water is, on the one hand, required for wastewater which is used in ponds or fish tanks as well as in particular for providing drinking water. An essential area of application of the inventive device is, however, the renovation of surface water for providing drinking water, and that is why the following description is referenced to this area of application.

As can be seen from FIG. 1. the wastewater stream WO flows through a pipe stub 7d into a distributor tube 7 and flows from the drainage pipe stubs 7a, 7b, 7c through flexible insulating material tubes 6 into the insulating material nozzles 2a, 2b, 2c.

The insulating material nozzles 2 contain holes or slits out of which the wastewater enters into the anode granulate. The insulating material nozzles 2 are inserted into the supporting plate 1 such that enough metallic contact surface 1a out of noble material is at hand in order to guarantee a definite electrical connection with the anode granulate 1.

As can be seen from FIG. 1, the metallic anode granulate 1c is in a cell box 3 which is slightly enlarged in the direction to the top. The cell box has one or several drainage openings 3b and is filled up with water up to the liquid level 4d. Above the anode granulate 1c but below the liquid level 4d, one or several metal grids 4 are arranged by means of a support 4a. The supports 4a serve at the same time also as a holder for supplying current to the metal grid 4. The metal grid is placed into periodical oscillations by means of a mechanic shaker or vibrator 4b. The power supply cable 4c is connected to the negative pole of the direct current generator 5.

The anode granulate rests on the noble metal layer 1a with which the supporting plate 1 is covered. The supporting plate 1 is connected fluid tightly to the cell box 3 by means of the flange 3a. The metallic supporting plate 1 is, furthermore, connected to the positive pole of the direct current generator 5 by means of the current cable 1b.

Furthermore, the tube distributor comprises at least two gas injectors extending into the tube distributor for a pulsed supply of driving gas, which are identified by 7e. As driving gas, preferably compressed air or compressed nitrogen is used.

A pulse control unit 4 opens temporarily the gas valve 8 which is connected to the high pressure conduit for the driving gas 8a. Therefore, a certain amount of driving gas arrives at the tube distributor 7 which is filled with wastewater, and accumulates mainly in the upper area of the tube of the horizontally supported tube distributor 7 because of the hydraulic conditions. Correspondingly, the pulse-injected gas amount exits mainly through the outlet pipe stub row b corresponding to a partial amount of the gas though the outlet pipe stub 7b. By means of the supply of pressurized air in intervals into the electrode granulate 1c, it is kept in a slow motion such that no clogging of the cell E and no uneven discharge of the miniature particles can happen.

Because of the large specific surface of the electrode granules 1c, the smallest microorganisms and suspended miniature particles upon flowing of WF through E are immediately electrically charged and accumulate. At the same time, metal hydroxide dissolved from the anode granulate 1c into the water is generated which produces filterable flocculates out of the accumulated micro particles.

The electro flocculate WF flows out of E through the drainage pipe stubs 3b through the input opening R11 into the ripening tank R. The ripening tank R is divided up into two tank volumes by means of the separating wall R13. One half of the tank is filled up with electro flocculate up to the liquid level WL1. The electro flocculate WF flows through slit R14 in the separating wall R13 into the second tank half which is filled up with electro flocculate up to the liquid level WL2. Coarse particles which are flushed out of the cell E into the ripening tank R, settle at the bottom and can be drained out of the ripening tank R through the conduits R16 and R17 by means of the valve V5 and V6 from time to time. By means of the ripening process in R, the electro flocculate WF is transformed into an easily filterable state with a good capability for back-washing.

Air L is flown into the lower tank of the ripening tank R by means of the tube conduit R18 in order to treat the electro flocculate with air.

The ripened electro flocculate flows out of the ripening tank R through the T-pipe stub R15 to the intake conduit L1 to the filter pump P1. In the filter pump P1, the ripened electro flocculate WF is subjected to filter pressure and flows out at the outlet pipe stub of the pump P1 through the conduit L2 and the opened checked valve V1 into the filter pipe stub L3 of the pressure filter F. The check valve V2 is closed whereby electro flocculate WF is flowing forcedly through the filter line F12 and out of the liquid distributor F11 into the filter space of F above the filter bed F13.

The filter bed F13 consists out of a loosely poured granular filter material. Upon passage from above to below through the filter bed F13, the electro flocculate WF loses all suspended particles and the suspended metal hydroxide generated in the electro flocculation cell E as well as certain contamination materials which have been attached to the generated metal hydroxide chemically or by means of Van der Waal's forces.

The thus purified filtrate passes through the slits of the filter columns F15 into the collector F14 and exits the pressure filter F through the filtrate water line L5. During the filter operation, the valve V3 connected to the conduit L5, is opened whereas the check valve V4 is closed. Therefore, the filtrate water flows out of the pressure filter F through the valve V3 into the conduit L6 which leads to the input pipe stub U13 of the UV light purification device U.

The UV light purification device U has the shape of a box-like channel within which one or more ultraviolet radiators U11 are horizontally arranged below the liquid level WL4. The filtrate entering through the input pipe stub U13 flows along one or several ultraviolet radiators U11 and exits from the UV light purification device U across an overflow weir U12 as sterile clean water through the opening T12 into the purified water tank T.

During the filtering operation, the purified water tank T is filled up to the liquid level WL3 with purified water. The purified water stream WD exits the clean water tank T through the drainage pipe stub T11.

After laps of a predefined time interval, the capacity of the filter bed F13 is exhausted and the filter F has to be back-washed for some minutes. For this purpose, the input of wastewater WO is interrupted, and the valve V1 and the valve V3 are closed, and the pump P1 is switched on. The valve V2 and the valve V4 are opened, and the pump P2 is switched on.

Through the drainage pipe stub T13 of the clean water tank T, clean water gets through the conduit L7 into the pump P2 and is pumped through the opened valve V4 and the conduit L5 into the distributor head F14. The clean water stream flows out of the filter distributor F15 from below to above through the filter bed F13 which is expanded thereby. The free space in the expanded filter bed F13 makes it possible that all of the particles deposited on the filter granulates and coagulated materials are flowing upwards together with the washing water stream. Through F11, F12, L3 and the opened valve V2, the washing water stream WS exit the inventive device for water renovation through the conduit L4.

After finishing the back-washing procedure, the input of wastewater WO is continued, and the valve V1 and valve V3 are opened, and the pump P1 is switched on. The valve V2 and the valve V5 are closed, and the pump P2 is switched of.

According to the invention, the device for water renovation preferably operates with zeolite as granular filter material F13, in particular the zeolite material clinoptilolite in a grade of at least 94% by weight clinoptilolite is used for the granular filter material of the inventive device.

### EXAMPLE

The space requirement for the inventive device for obtaining drinking water out of a river, a lake or a pond for 1000 inhabitants corresponding to 200 cubic meter drinking and usage water per day:

The inventive device for water renovation according to the method procedure described in FIG. 1, is compact to such an extend that the total device described in FIG. 1 including the associated, back-washable pressure filter with filter material out of granular zeolite fits into a standard 20-foot-container.

Furthermore, the inventive device also operates without failure also with a heavily fluctuating wastewater load, requires no continuous supervision and requires only about 20% of the required electrical energy of comparable water renovation plants.

1. Method for renovation of wastewater in which
the wastewater is fed into an electro flocculation cell and is subjected there to an electro flocculation,
the electro flocculate treated in the electro flocculation cell is fed into a ripening tank and remains there, the electro flocculate is enriched by air prior to being fed to the filter and
the electro flocculate coming from the ripening tank is filtered in a filter, the water is conveyed under pressure through the filter.

2. (canceled)

3. Method according to claim 1, wherein the dwell time of the electro flocculate in the ripening tank amounts to 0.5 to 3 hours.

4. (canceled)

5. Method according to claim 1, wherein the filter comprises a filter bed with granular filter material, wherein an overpressure is built up in the filter which is sufficient to press the electro flocculate through the filter bed.

6. Method according to claim 1, wherein the water coming from the filter, is irradiated in a UV light purification device with ultraviolet light.

7. Device for renovating of wastewater comprising:
an electro flocculation cell
wherein the electro flocculation cell is constructed with movable electrodes and comprises an input for wastewater and a drainage for the electro flocculate,
a ripening tank connected downstream of the electro flocculation cell wherein the ripening tank comprises an ventilation element for the supplying air,
a filter which is connected downstream of the ripening tank, comprises a filter bed with a moveable, granular filter material and is formed as a pressure container.

8. (canceled)

9. Device according to claim 7, wherein the electro flocculation cell comprises an upper and a lower electrode which is movable, wherein the lower electrode comprises a bed out of metal particles and the upper electrode out of metal is adapted to be oscillated mechanically.

10. Device according to claim 9, wherein the movable electrode material consists out of cast iron chips or out of magnesium granulate or out of aluminum granulate or out of a granular aluminum magnesium alloy.

11. (canceled)

12. Device according to claim 7, wherein the ripening tank is constructed as unpressurized tank.

13. Device according to claim 7, wherein the ripening tank is divided up by means of separating walls into further sub-tanks which are connected to each other hydraulically through openings in the separating walls.

14. Device according to claim 13, wherein the sub-tanks of the ripening tank comprise aeration tubes.

15. Device according to claim 7, wherein the filter is capable of being back-washed.

16. (canceled)

17. (canceled)

18. Device according to claim 7, wherein the granular filter material of the filter consists out of zeolite.

19. Device according to claim 18, wherein the granular filter material of the filter consists out of clinoptilolite.

20. Device according to claim 19, wherein the granular filter material consists out of the zeolite material clinoptilolite in a grading of at least 94% per weight clinoptilolite.

21. Device according to claim 10, wherein a UV light purification device is connected downstream of the filter.

22. Device according to claim 21, wherein the UV light purification device has the shape of a box like channel within which one or several ultraviolet radiators are horizontally arranged below the liquid level (WL4) and in which an overflow weir for sterile clean water is provided.

23. Device according to claim 7, wherein a clean water tank is provided.

24. Device according to claim 23, wherein the clean water tank is constructed as an unpressurized tank.

25. Device according to claim 23, wherein the clean water tank is configured to contain the back-washing water for the filter.

26. Device according to claim 23, wherein the clean water tank has the 4-fold to 6-fold volume of the filter.
